(19) United States
(12) Patent Application Publication
(10) Pub. No.: US 2017/0345447 A1
(43) Pub. Date: Nov. 30, 2017

(54) METHOD OF DETECTING SLIDER TRAILING EDGE FOR FORMING ELECTRICAL CONNECTIONS

(71) Applicant: Seagate Technology LLC, Cupertino, CA (US)

(72) Inventors: Pongsith Dharachantra, Bangkok (TH); Jonathan P. Robelia, Richfield, MN (US)

(21) Appl. No.: 15/165,495

(22) Filed: May 26, 2016

(51) Int. Cl. G11B 5/127; G11B 5/48; G01B 11/00

(52) U.S. Cl. CPC G11B 5/1272; G01B 11/002; G11B 5/4826

(57) ABSTRACT

A method of forming an electrical interconnection between a first slider pad of a slider and an adjacent first suspension pad of a suspension, wherein the slider is attached to the suspension, including the steps of positioning the suspension and attached slider at a soldering angle, wherein the slider comprises a trailing edge, measuring at least an x-coordinate and a z-coordinate of a trailing edge of the slider to determine a position of the trailing edge of the slider, analyzing the position of the trailing edge of the slider to determine a bonding location of the slider, positioning a capillary tube above the suspension pad and slider at a distance calculated from the bonding location of the slider, and dispensing solder from the capillary tube for contact with the first slider pad and the first suspension pad.

### BACKGROUND

Hard disk drive (HDD) systems typically include one or more data storage disks with concentric tracks containing information. A transducing head carried by a slider is used to read from and write to a data track on a disk, wherein each slider has an air bearing surface that is supportable by a cushion of air generated by one of the rotating disks. The slider is carried by an arm assembly that includes an actuator arm and a suspension assembly, which can include a separate gimbal structure or can integrally form a gimbal.

As the density of data desired to be stored on disks continues to increase, more precise positioning of the transducing head and other components is becoming increasingly important. In many conventional systems, head positioning is accomplished by operating the actuator arm with a large scale actuation motor, such as a voice coil motor, to position a head on a flexure at the end of the actuator arm. A high resolution head positioning mechanism, or microactuator, is advantageous to accommodate the high data density.

The manufacturing of components of HDD systems often includes providing an electrical connection via solder material between sliders and suspension assemblies, either of which may include bonding pads. This solder material is often supplied to a component via solder jetting, which can have at least some inherent trajectory error and possible solder ball expansion upon impact with a surface to which it is applied that can lead to inadequate separation between pads and traces. This can then lead to bridging or open connections, particularly in high-density applications. Not only is there becoming greater need for more device bond pads, less area for these bond pads is available as sliders continue to shrink in size to accommodate higher density of data storage and smaller disk drives. Thus, there is a desire to provide additional solder placement techniques that allow for accurate solder connections in high density applications.

### SUMMARY

Aspects of the invention described herein are directed to the processing of solder materials to provide for accurate attachment and interconnect of sliders to their associated head gimbal assemblies in hard disk drives. Such methods and configurations are particularly beneficial with the continuing desire to decrease the size of electronic components in the data storage industry. In particular, aspects of the invention are directed to accurately detecting a trailing edge of a slider and positioning a solder dispensing device relative to the trailing edge for dispensing solder to form electrical interconnections between components.

In an aspect of the invention, a method is provided for interconnecting multiple components of a head-gimbal assembly with a solder joint, wherein the electrical interconnection can be between a first slider pad of a slider and an adjacent first suspension pad of a suspension, wherein the slider is attached to the suspension. An exemplary method includes positioning the suspension and attached slider at a soldering angle relative to a solder dispensing device, wherein the slider comprises a trailing edge, then measuring at least an x-coordinate and z-coordinate of a trailing edge of the slider to determine a position of the trailing edge of the slider, analyzing the position of the trailing edge of the slider to determine a bonding location of the slider, positioning a capillary tube above the suspension pad and slider at a distance calculated from the bonding location of the slider, and dispensing solder from the capillary tube for contact with the first slider pad and the first suspension pad.

These and various other features and advantages will be apparent from a reading of the following detailed description.

### BRIEF DESCRIPTION OF THE DRAWINGS

The present invention will be further explained with reference to the appended Figures, wherein like structure is referred to by like numerals throughout the several views, and wherein:

FIG. 1 is a perspective view of a load beam area of a hard disk drive system;

FIG. 2 is a perspective view of multiple head suspension assemblies arranged in an exemplary bonding operation relative to a surface measurement instrument positioned for slider location measurements;

FIG. 3 is a schematic side view of an exemplary process of releasing a solder ball from a capillary for forming an electrical interconnection between a slider pad and a suspension pad that are adjacent to and positioned at an angle relative to each other; and

FIG. 4 is an exemplary graphic representation of measurements taken of physical locations of predetermined slider parameters.

### DETAILED DESCRIPTION

The methods of the present invention are useful in assembling hard disk drives, which can generally include a magnetic recording disk that is rotated by a hub that is mechanically driven by drive motor. A read/write head or transducer is located on a trailing end or surface of a slider, wherein a slider is operatively connected to a head suspension assembly that includes a gimbal or flexure element for permitting the slider to move in multiple directions (e.g., in pitch and roll directions) relative to a spinning disk. The gimbal or flexure can be created integrally with the head suspension assembly or as a separate component and attached to the head suspension assembly. The suspension assembly provides a bias force that urges the slider toward the surface of a disk. During operation of the disk drive, drive motor rotates disk at a constant speed while an actuator, which can be a linear or rotary motion coil motor, drives the slider generally radially across the plane of the surface of disk so that read/write head may access different data tracks on disk.

The read/write heads described above are carried by a slider that is used to read from and write to a data track on a disk. The slider is carried by an arm assembly that includes an actuator arm and a suspension assembly, which can include a separate gimbal structure or can integrally form a gimbal.

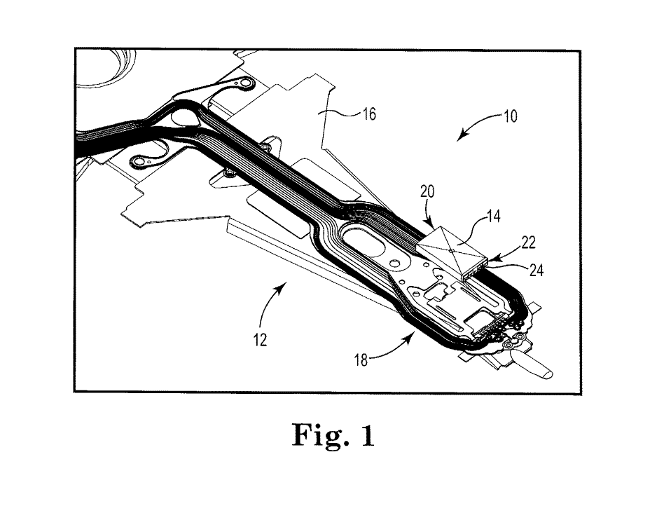

Referring now to the Figures, wherein the components are labeled with like numerals throughout the several Figures, and initially to FIG. 1, an exemplary configuration of a head gimbal assembly 10 is illustrated, which includes a trace gimbal assembly (TGA) 12 to which a slider 14 is mountable. The trace gimbal assembly 12 includes a load beam 16 that is attached to a gimbal area 18.

The slider 14 includes a leading edge 20 and an opposite trailing edge 22. The trailing edge 22 includes a series of electrical contacts or bond pads 24 arranged in a row along a portion of its width. The number of bond pads provided on a trailing edge of a particular slider can vary considerably, and a number of arrangements and spacing of the slider bond pads are contemplated. In an exemplary embodiment, between nine and eleven slider bond pads are provided for a particular slider configuration, although more or less bond pads are contemplated. Each of the slider bond pads is positioned adjacent to a corresponding suspension bond pad that is located on the suspension for the process of forming an electrical interconnection between them. Because the bond pads are very small and are positioned extremely close to each other to accommodate the large number of electrical connections to be formed for each slider, accurate placement of solder material for each electrical interconnection is increasingly important. It is further noted the amount of solder applied for each connection will typically be relatively small to prevent bridging of solder material to adjacent bond pad pairs. This provides further challenges, as the solder applicator (e.g., a capillary) for smaller volumes of solder material will generally need to be positioned even closer to the slider and bond pads for accurate solder placement than when the pads are spaced further from each other.

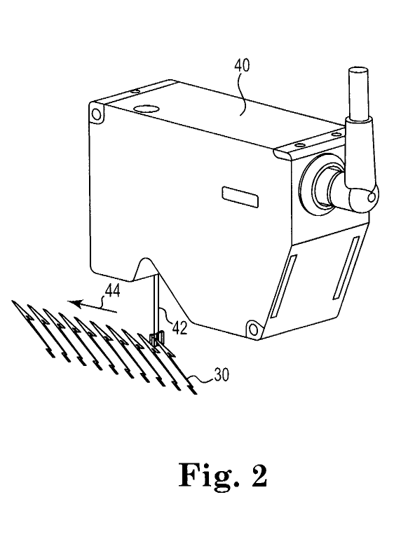

FIG. 2 is a partial perspective illustration of multiple head suspension assemblies 30 arranged in an exemplary measurement operation relative to a surface measurement instrument 40. While FIG. 2 illustrates a system that measures a grouping or batch of ten head suspensions 30, it is contemplated that more or less than ten head suspensions 30 would be used in a single batch. In an exemplary embodiment, measurement instrument 40 can be a profilometer that uses a non-contact measurement process (e.g., one or more lasers) that are used for measuring a 2-D profile of a surface, such as by using light stripe triangulation. In fact, such a measurement instrument 40 can first be used to determine the 2-D measurements of aspects of the head suspension assemblies 30, and then can further be used to measure a third component of the position of that same aspect or features of the head suspension 30. In an exemplary embodiment, the x-component and y-component are measured for the 2-D profile, with the z-component additionally being obtained during the measurement process and utilized in methods of the invention.

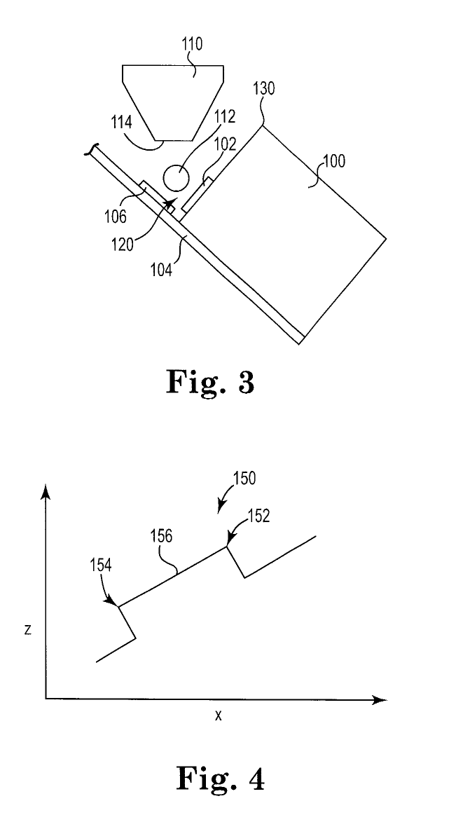

Referring additionally to FIG. 3, a schematic view is provided of an exemplary method for electrically connecting two orthogonal elements, such as a slider bond pad 102 of a slider 100 and a suspension bond pad 106 of a suspension 104. These elements are generally associated with or extend from other elements of a hard disk drive components, wherein only a distal portion of such elements of are shown for clarity of illustration purposes. These components are attachable to each other using solder material that is provided to the soldering area 120 in the area where the slider bond pad 102 and suspension bond pad 106 are closest to each other.

A capillary 110 is positioned above the slider 100 and suspension 104 such that solder material exiting the capillary will fall and/or be jetted toward two components that are to be electrically connected to each other. The capillary 110 can have a wide variety of different sizes and shapes; however, an embodiment of the capillary 110 used in the methods of the invention can include a structure that includes a center opening 114 that is at least partially surrounded by walls that are sloped or tapered from the area in which a solder sphere enters the capillary to the area where the solder sphere exits the capillary. That is, the capillary 110 can be substantially conic with a hollow inner area.

The capillary 110 with the central opening 114 is positioned such that its longitudinal axis is directly above the area onto which it is desired to deposit solder material. In this way, the solder sphere uses gravity and/or the pressure that is pushing the solder sphere from the capillary to move a solder sphere 112 to its target location. In an embodiment where the target surfaces (e.g., surfaces of slider bond pad 102 and suspension bond pad 106) are perpendicular to each other, the angle between the longitudinal axis of the central opening 114 of the capillary 110 and the target surfaces will be approximately 45 degrees. However, it is contemplated that the capillary or other solder dispensing mechanism can be positioned differently relative to the target soldering location.

In an exemplary embodiment, the solder sphere 112 is provided to the capillary 110 from a solder sphere source or reservoir (not shown), wherein the solder sphere material, size, shape, and the like are selected to provide a desired connection between components once the solder material is placed and formed in a target location. Pressure can be applied to the capillary 110, such as with a pressurization gas pressing downwardly against the solder sphere 112 until it is positioned at the outlet or central opening 114 of the capillary 110. Continued pressure can continue to be applied, which thereby increases the pressure within the capillary 110 until a predetermined pressure value is reached, and then the sphere 112 is dispensed or jetted from the capillary 110. Alternatively, the solder sphere may be dispensed in a way that does not involve the use of pressurized gas. In any case, due to the increased density of electrical connections required for each slider, the capillary 110 needs to be increasingly close to the components of the system without contacting such components in order to accurately dispense solder to a desired location. This extremely close proximity requires an increased accuracy of measurements so that the capillary does not unintentionally come in physical contact with any of the components during the solder dispensing process.

Referring again to FIG. 2, the surface measurement instrument 40 projects at least one laser 42 toward each head suspension assembly 30 in sequence to obtain 2-D information, wherein the measurement instrument 40 can move in a direction represented by arrow 44. In a first phase of an exemplary embodiment, which may be referred to as a “learning phase,” a 2-D profile analysis is performed to determine two positional data points for a trailing edge 130 of slider 100, wherein an exemplary depiction of a 2-D profile 150 of a slider is illustrated in FIG. 4. The two positional data points of the trailing edge 130 may be the trailing edge height (i.e., the z-component) and the trailing edge position (i.e., the x-component). The 2-D profile attributes that can be determined in this phase include a set of measurements of a trailing edge of a slider that correspond to other 2-D profile features (e.g., trailing edge to the air bearing surface (ABS), the trailing edge to the leading edge, and the like), along with a set of measurements of a trace gimbal assembly 2-D profile, such as an ABS angle, trailing edge profile roughness, and the like. The trailing edge of the 2-D profile of the slider is illustrated in FIG. 4 at point 152 of the graph, with the leading edge of the 2-D profile of the slider being illustrated in FIG. 4 at point 154, and the surface 156 between the trailing edge 152 and the leading edge 154 being represented by line 156 (i.e., the air bearing surface).

The learning phase then includes a step of measuring multiple actual trace gimbal assembly samples of a group and collecting the data. The measurements may be taken at locations along the trailing edge of the slider. The trailing edge height (e.g., z-component) and position (e.g., x-component) data is then analyzed using a statistical outlier method to identify measurements that are outside a desired range. The standard deviations of the 2-D profile attributes of the measurements that are within a desired range are then determined and analyzed in order to set up tolerances for profile attributes (e.g., +/−2 sigma or +/−6 sigma from average values).

A deployment phase of the electrical connection formation method can occur after the information is collected in the first phase of the process. In the deployment phase, multiple measurements are taken for each trace gimbal assembly (for example, 10-20 measurements can be taken, although there may be more or less than this range of measurements that are taken). The multiple measurements may be taken along the trailing edge of a slider, wherein these measurements may be “on the fly” continuous scanning to provide for high throughput. The measurements may be taken with the measurement instrument 40 described relative to FIG. 2, which may be a 2D profilometer, for example. Alternatively, another measurement instrument can be used. The 2D profile attributes of each measurement can then be compared to the tolerances obtained in the learning phase so that measurements within a particular acceptable range can be analyzed. That is, the measurements within an acceptable range can be analyzed relative to the trailing edge height (e.g., z-component) and trailing edge position (e.g., x-component), and the data can be filtered to recognize spikes, such as can be accomplished by using a time-domain spike analysis. In order to determine the final trailing edge height measurement for placement of the capillary relative to its soldering location, the trailing edge height values (e.g., x-component and z-component) of the components that are within the desired range are averaged. At this point, the capillary can be located at a desired location that will be used for the dispensing of solder to all of the head suspensions within the grouping of components being considered.

The present invention has now been described with reference to several embodiments thereof. The foregoing detailed description and examples have been given for clarity of understanding only. No unnecessary limitations are to be understood therefrom. It will be apparent to those skilled in the art that many changes can be made in the embodiments described without departing from the scope of the invention. The implementations described above and other implementations are within the scope of the following claims.

What is claimed is:

1. A method of forming an electrical interconnection between a first slider pad of a slider and an adjacent first suspension pad of a suspension, wherein the slider is attached to the suspension, the method comprising the steps of:
positioning the suspension and attached slider at a soldering angle, wherein the slider comprises a trailing edge;
measuring at least an x-coordinate and a z-coordinate of a trailing edge of the slider to determine a position of the trailing edge of the slider;
analyzing the position of the trailing edge of the slider to determine a bonding location of the slider;
positioning a capillary tube above the suspension pad and slider at a distance calculated from the bonding location of the slider; and
dispensing solder from the capillary tube for contact with the first slider pad and the first suspension pad.

2. The method of claim 1, wherein the step of measuring the first and second coordinates comprises projecting at least one laser with a measurement instrument.

3. The method of claim 2, wherein the measurement instrument comprises a 2-D profilometer.

4. The method of claim 1, wherein the analyzing step further comprises filtering positional information of the trailing edge of the slider to recognize spikes.

5. The method of claim 1, wherein the method further comprises forming an electrical interconnection between at least a second slider pad of the slider and at least a second suspension pad of the suspension subsequent to forming the electrical interconnection between the first slider pad and the first suspension pad.

6. The method of claim 5, wherein trailing edge x-coordinate and z-coordinate measurements are averaged prior to the step of positioning the capillary tube to calculate average x-coordinate and y-coordinate values that are used for positioning the capillary tube relative to at least the first and second slider pads and at least the first and second suspension pads.

7. A method of interconnecting multiple components of an electrical assembly with a solder joint, comprising the steps of:
positioning a first component adjacent to a second component to provide a bonding area between the first and second components;
measuring at least a first coordinate and a second coordinate of an edge of the first component to determine a position of the edge of the first component;
analyzing the position of the edge of the first component to determine a bonding location of the first component;
positioning a capillary tube above the first and second components at a distance calculated from the bonding location of the first component;
dispensing solder from a capillary tube, wherein the capillary tube is positioned with an exit orifice above the connection area between the first and second components.

8. The method of claim 7, wherein the electrical assembly comprises a head-gimbal assembly, wherein the first component comprises a slider, and wherein the second component comprises a trace gimbal assembly.

9. The method of claim 8, wherein the step of measuring first and second coordinates of the edge of the slider comprises correlating the measured first and second coordinates to an air bearing surface.

10. The method of claim 8, wherein the step of measuring first and second coordinates of the edge of the slider comprises correlating the measured first and second coordinates to a leading edge of the slider.

11. The method of claim 7, wherein the step of measuring the first and second coordinates comprises projecting at least one laser with a measurement instrument.

12. The method of claim 11, wherein the measurement instrument comprises a 2-D profilometer.

13. The method of claim 7, wherein the analyzing step further comprises filtering positional information of the edge of the first component to recognize spikes.
